(19) United States
(12) Patent Application Publication
(10) Pub. No.: US 2006/0250421 A1
(43) Pub. Date: Nov. 9, 2006

(54) System and Method to Determine a Visibility Solution of a Model

(75) Inventors: Timothy R. Anderson, Huntsville, AL (US); Ronald T. Conerly, Huntsville, AL (US); Aditya Gurushankar, Huntsville, AL (US); Daniel C. Staples, Huntsville, AL (US); Mallikarjuna Gandikota, Huntsville, AL (US); Prasad Pingali, Huntsville, AL (US)

Correspondence Address: UGS CORP., 5800 GRANITE PARKWAY, SUITE 600, PLANO, TX, 75024, US

(73) Assignee: UGS Corp., Plano, TX (US)

(21) Appl. No.: 11/278,100

(22) Filed: Mar. 30, 2006

Related U.S. Application Data
(60) Provisional application No. 60/666,973, filed on Mar. 31, 2005.

(51) Int. Cl. G09G 5/00

(52) U.S. Cl. 345/629

(57) ABSTRACT

A system, method, and computer program for determining a visibility solution of a model comprising the steps of rendering a model having a plurality of parts with at least one color value encoded for an at least one corresponding surface identity; distinguishing a plurality of exterior parts from a plurality of interior parts based on said at least one corresponding surface identity; and identifying a plurality of features in said model not copied into a composite image and appropriate means and computer-readable instructions.

### PRIORITY OF APPLICATION

The present application claims priority of U.S. Provisional Application Ser. No. 60/666,973 filed Mar. 31, 2005, which is incorporated herein by reference.

### TECHNICAL FIELD

This invention relates generally to computer graphics. More specifically, the invention relates to a system and method of determining a visibility solution of a CAD assembly.

### BACKGROUND

The computer has greatly affected essentially all forms of information management, including computer aided design and drafting (CAD) tools. Some simpler geometric modeling computer program products can only model in two dimensions at a time, while more complex and powerful computer program products provide three dimensional editing and visualization capabilities.

Three dimensional geometric modeling programs can generate a complex high-level assembly that can comprise one or more constituent 3D solid shapes. For example, a table assembly could comprise a solid shape for each leg of the table, where each leg is an identical design placed relative to each other, as well as a solid shape for a flat table top. Today, however, CAD representations are becoming more and more complex; typically combining numerous intricate 3D drawings to create a final product like an airplane, a car or even a factory. Each level of abstraction requires various degree of granularity, particularly when it comes to comparing manufacturing versus bill of material information versus conceptual design. Likewise, when rendering a 3D model in its entirety, a computer requires considerable resources from its central processing unit (CPU) and/or random access memory (RAM), for example. In the industry, it is common to spend hours to days of computing time to render a highly complex structure.

The increased rendering time places a burden on computer systems and organizations that desire rapid progression from design to development. Therefore, when designing the 3D model of the high-level structure, manufacturing entities have a need to reduce rendering times of each of the individual sub-assemblies that comprise the higher-level assembly while maintaining the design integrity of the entire design concept.

Furthermore, users of CAD systems require various levels of product structure where at one end there is a need for detailed design information, and at the other end, a simplified representation is needed. That being said, those users have to easily switch between simplified and design representations throughout the product design process, while maintaining constant product definition. Those same users want to balance the ability to freely deliver to third parties a simplified representation of 3D models that does not divulge potential intellectual property with sufficient detail to communicate the product design.

There is a need for a solution that can efficiently and effectively simplify the 3D representation of a designed product particularly at various levels of design when various needs for detailed information is required. There is also a need for a solution that can provide the ability for a user to deliver some level of product detail to prospective customers and clients without unintentionally divulging proprietary information.

### SUMMARY

To achieve the foregoing, and in accordance with the purpose of the presently preferred embodiment as broadly described herein, the present invention provides a method to determine a visibility solution of a model comprising the steps of rendering a model having a plurality of parts with at least one color value encoded for an at least one corresponding surface identity; distinguishing a plurality of exterior parts from a plurality of interior parts based on said at least one corresponding surface identity; and identifying a plurality of features in said model not copied into a composite image. The method, further comprising the step of displaying said plurality of parts from at least one orientation. The method, further comprising the step of displaying said composite image comprised of said exterior parts and lacking said plurality of features. The method, further comprising the step of preparing said model to improve accuracy of a rendering operation. The method, further comprising the step of implementing at least one filtering algorithm to adjust a quality of analysis of said rendering. The method, further comprising the step of preparing said model to adjust accuracy of a rendering operation wherein said accuracy is adjusted by tessellating said model. The method, wherein said step of rendering operates to depict said model as a tessellated version of a geometrical representation of a plurality of surfaces.

Another advantage of the presently preferred embodiment is to provide a computer-program product tangibly embodied in a machine readable medium to perform a method to determine a visibility solution of a model, comprising instructions for rendering a model having a plurality of parts with at least one color value encoded for an at least one corresponding surface identity; instructions for distinguishing a plurality of exterior parts from a plurality of interior parts based on said at least one corresponding surface identity; and instructions for identifying a plurality of features in said model not copied into a composite image. The computer-program product, further comprising the instructions for displaying said plurality of parts from at least one orientation. The computer-program product, further comprising the instructions for displaying said composite image comprised of said exterior parts and lacking said plurality of features. The computer-program product, further comprising the instructions for preparing said model to improve accuracy of a rendering operation. The computer-program product, further comprising the instructions for implementing at least one filtering algorithm to adjust a quality of analysis of said rendering. The computer-program product, further comprising the instructions for preparing said model to adjust accuracy of a rendering operation wherein said accuracy is adjusted by tessellating said model. The computer-program product, wherein said instructions for rendering operates to depict said model as a tessellated version of a geometrical representation of a plurality of surfaces.

Another advantage of the presently preferred embodiment is a data processing system having at least a processor and accessible memory to implement a method to determine a visibility solution of a model, comprising means for rendering a model having a plurality of parts with at least one color value encoded for an at least one corresponding surface identity; means for distinguishing a plurality of exterior parts from a plurality of interior parts based on said at least one corresponding surface identity; and means for identifying a plurality of features in said model not copied into a composite image.

Still another advantage of the presently preferred embodiment is a computer-program product for determining a visibility solution of a model, the solution comprising a rendering operation on a model, wherein said rendering operation encodes a plurality of parts with at least one color value to at least one corresponding surface identity; a plurality of exterior parts distinguished from a plurality of interior parts based on said at least one corresponding surface identity; whereby said model displays a composite image of said exterior parts.

And yet another advantage of the presently preferred embodiment is a computer-program product for determining a visibility solution of a model, the product comprising a rendering operation that receives a prepared model, wherein said preparation adjusts accuracy of said rendering operation; at least one filtering algorithm to adjust a quality of analysis following said rendering operation; whereby said model is a tessellated version of a geometric representation of a plurality of surfaces.

A further advantage of the presently preferred embodiment is a visibility solution of a model embodied on a computer-readable medium on a computer in conjunction with a application, the visibility solution comprising a reduced form of said model derived from a designed form of said model, having a plurality of exterior faces, wherein said exterior faces consist of a plurality of components from said design form.

And a further advantage of the presently preferred embodiment is a method to determine a visibility solution of a model comprising the steps of implementing at least one filtering algorithm to adjust a quality of analysis of said rendering; preparing said model to adjust accuracy of a rendering operation wherein said accuracy is adjusted by tessellating said model; rendering a model having a plurality of parts with at least one color value encoded for an at least one corresponding surface identity, operating to depict said model as a tessellated version of a geometrical representation of a plurality of surfaces; distinguishing a plurality of exterior parts from a plurality of interior parts based on said at least one corresponding surface identity; identifying a plurality of features in said model not copied into a composite image; displaying said plurality of parts from at least one orientation; and displaying said composite image comprised of said exterior parts and lacking said plurality of features.

Other advantages of the presently preferred embodiment will be set forth in part in the description and in the drawings that follow, and, in part will be learned by practice of the invention.

The presently preferred embodiment will now be described with reference made to the following Figures that form a part hereof. It is understood that other embodiments may be utilized and changes may be made without departing from the scope of the present invention.

### BRIEF DESCRIPTION OF THE DRAWINGS

A presently preferred embodiment will hereinafter be described in conjunction with the appended drawings, wherein like designations denote like elements, and:

FIG. 1 is a block diagram of a computer environment in which the presently preferred embodiment may be practiced;

FIG. 2 is a logic flow diagram for a visibility solution in the presently preferred embodiment;

FIG. 3 is an illustration of a detailed logic flow diagram of the visibility solution in the presently preferred embodiment;

FIG. 4 is a 3D housing in an axonometric orientation;

FIG. 5 is an illustration of an orthogonal plane view of a shaft extended through a hole;

FIG. 6 is a design representation of a 3D assembly model in axonometric orientation;

FIG. 7 is a 3D assembly model in axonometric orientation in one solid color with each part initially identified as interior;

FIG. 8 is an illustration of an orthogonal orientation of the gear reducer assembly;

FIG. 8 is an illustration of a partial view of a gear reducer assembly;

FIG. 9 is an illustration of a close-up view of a bolt, showing exterior faces as white, and an interior face as magenta;

FIG. 10 is an illustration of an axonometric orientation of the gear reducer assembly in simplified representation; and

FIG. 11 is an illustration of a close-up view of a gear reducer assembly following a visibility solution where a hole and a plurality of bolts are missing from a design representation.

### DETAILED DESCRIPTION OF THE PREFERRED EMBODIMENTS

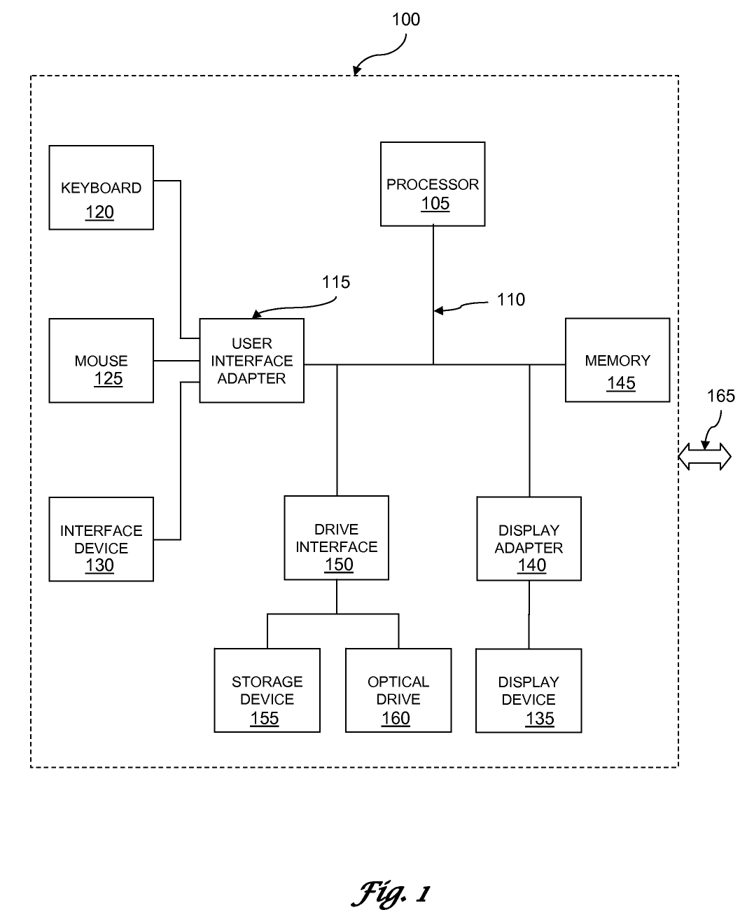

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method to determine a visibility solution of a computer aided design (CAD) assembly. Now therefore, in accordance with the presently preferred embodiment, an operating system executes on a computer, such as a general-purpose personal computer. FIG. 1 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types and the presently preferred embodiment may be performed in any of a variety of known computing environments.

With reference to FIG. 1, an exemplary system for implementing the presently preferred embodiment includes a general-purpose computing device in the form of a computer 100, such as a desktop or laptop computer, including a plurality of related peripheral devices (not depicted). The computer 100 includes a microprocessor 105 and a bus 110 employed to connect and enable communication between the microprocessor 105 and a plurality of components of the computer 100 in accordance with known techniques. The bus 110 may be any of several types of bus structures including a memory bus or memory controller, a peripheral bus, and a local bus using any of a variety of bus architectures. The computer 100 typically includes a user interface adapter 115, which connects the microprocessor 105 via the bus 110 to one or more interface devices, such as a keyboard 120, mouse 125, and/or other interface devices 130, which can be any user interface device, such as a touch sensitive screen, digitized pen entry pad, etc. The bus 110 also connects a display device 135, such as an LCD screen or monitor, to the microprocessor 105 via a display adapter 140. The bus 110 also connects the microprocessor 105 to a memory 145, which can include ROM, RAM, etc.

The computer 100 further includes a drive interface 150 that couples at least one storage device 155 and/or at least one optical drive 160 to the bus. The storage device 155 can include a hard disk drive, not shown, for reading and writing to a disk, a magnetic disk drive, not shown, for reading from or writing to a removable magnetic disk drive. Likewise the optical drive 160 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 100.

The computer 100 can communicate via a communications channel 165 with other computers or networks of computers. The computer 100 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 145 of the computer 100. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

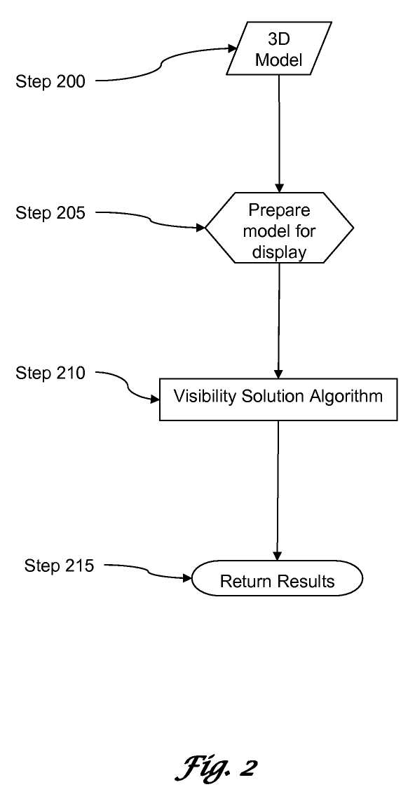

FIG. 2 is a logic flow diagram for a visibility solution in the presently preferred embodiment. The present application describes an innovative visibility solution practiced on a 3D CAD software application such as SolidEdge® by UGS Corp, whereby a user, also referred to as a designer, displays a 3D assembly model that includes at least one part, component and/or sub-assembly (Step 200). The 3D assembly model can be created natively on the 3D CAD software application, or can be copied into the current application. Likewise, the 3D assembly model can be designed and/or constructed by other methods commonly known in the art of 3D assembly design.

Following the display of the 3D assembly model, next the 3D assembly model is prepared for display to improve rendering accuracy, and if the 3D assembly model contains simplified geometry from a prior simplified representation operation, then the simplified geometry is displayed along with the other components of the 3D assembly model that have not been simplified (Step 205). Simplified geometry is a generic term to identify any part/component that has been simplified pursuant to the methods and teachings disclosed herein. Likewise, components not shown in the design representation view do not participate during the simplified representation mode in the creation of the simplified representation.

Further to preparing the 3D assembly model for display, the display color of the 3D assembly model is adjusted such that it is uniform throughout and initially characterizes all faces to be simplified as interior. In the simplified representation mode, the user can utilize the 3D software application to show/hide parts, activate/inactivate parts, show parts as simplified/designed, apply configurations, or change part styles using understood techniques. It is understood that the term “parts” refers to any structural element of the 3D assembly model, e.g., the face of a hex bolt is a “part” or the entire hex bolt could be a “part” as identified by the user.

Next, the user identifies which parts and/or components on the 3D assembly model the presently preferred embodiment will ignore in the creation of the simplified representation by using a graphic slider to ignore small parts based on a slider value and if desirable can manually select parts to ignore. The slider value can be adjusted to exclude a hole with a size of 0.05% of the area containing the surface, for example. It is understood that the percentage size could easily be more or less than 0.05%, depending on the design intent of the user and that 0.05% is an arbitrary value shown for demonstrative purposes only. Parts and components the designer identifies as “ignored” are not copied into the resulting simplified assembly representation, and those same ignored parts and components do not participate in a visibility solution to distinguish exterior faces from interior faces. Likewise, “small” can be hard-coded into the application disclosed such that the designer cannot modify the definition of small as compared to the surface area of the assembly and/or component.

Further to the teachings discussed, the user is able to manipulate a quality of analysis by selecting to render each surface of the 3D assembly model as a finely tessellated depiction of a geometric representation of each surface. The granularity of tessellation can vary from fine to coarse, where coarse tessellation forms larger polygons such as triangles, squares or hexagons, while fine tessellation forms smaller polygons. Tessellating and re-tessellating the 3D assembly model varies the quality of the analysis by ignoring interior faces that would otherwise be considered visible.

Once the 3D assembly model is prepared for display, the presently preferred embodiment utilizes a visibility solution to continue the process of simplification (Step 210). Following the visibility solution, the resulting composite image is returned for further processing and/or integration by the same or different 3D CAD software application (Step 215).

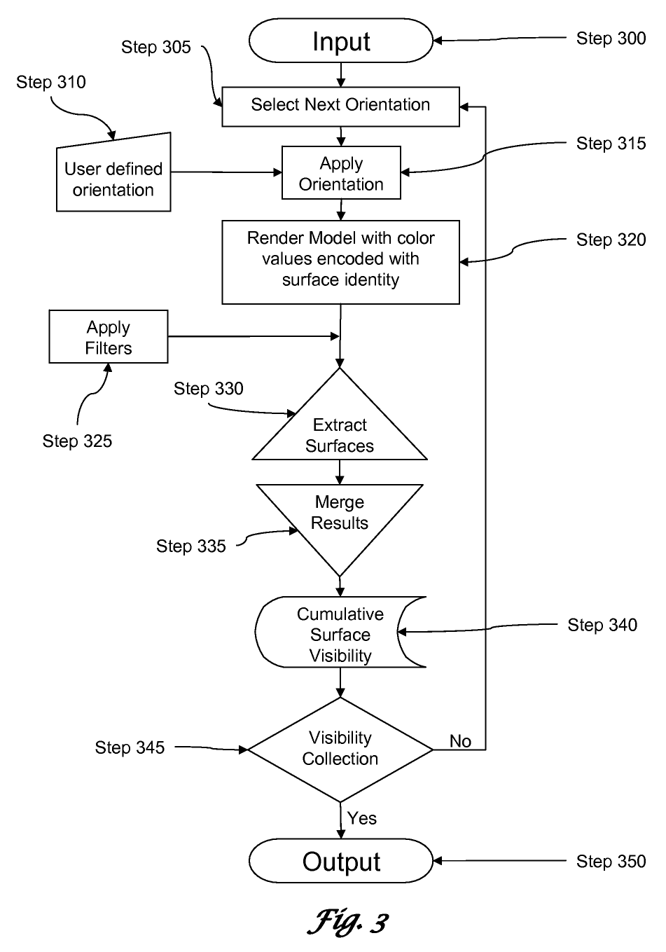

Turning to FIG. 3, a logic flow diagram of the visibility solution disclosed in greater detail, where it accepts as input the prepared 3D assembly model (Step 300). The disclosed preferred embodiment defaults to providing 24 orientations, where those orientations are orthogonal and/or axonometric (Step 305). The designer can also define additional orientations by freely rotating the 3D assembly model or using other means known in the 3D CAD industry and commonly known by users of 3D design applications (Step 310). The only limit to the number of desired orientations is the amount of time needed to process the orientations and accumulate the results of the visibility solution.

Next the visibility solution applies the orientation designated by the designer (Step 315). At that time, the designer can use further known techniques to manipulate the 3D assembly model to improve the quality of the rendering, for example, optimizing zoom scale to increase model coverage, optimizing depth buffer attributes, and adjusting orientation to decrease the amount of viewed surface area. In selecting said orientation, the designer can further adjust the quality of analysis by modifying the dimensions for the rendering process. For example, a width and height can be reduced to improve speed of the visibility solution but reduce the accuracy of the rendering.

Next, the resulting rendered image of the the 3D assembly model displays information that is used to determine the identify of each visible surface of each occurrence of each component in the 3D assembly model, where the displayed information is identified as one color for exterior processed surfaces and another color for interior surfaces (Step 320). The presently preferred embodiment employs the depth buffering feature of OpenGL to assign unique colors to each of the rendered surfaces. OpenGL is an open source graphics library that defines a cross-language cross-platform API for writing applications that produce 3D and 2D computer graphics. Depth buffering is a technique to determine which primitives in a model are occluded by other primitives such that as each pixel in a primitive is rasterized, its distance from the eye-point (depth value) is compared with the values stored in the depth buffer. Accordingly, if the pixel's depth value is less than the stored value, the pixel's depth value is written to the depth buffer, and its color is written to the color buffer.

Put another way, the depth buffering works by associating a depth, or distance, from the view plane with each pixel on the window so that the distance from the view pane is computed. With depth buffering enabled, before each pixel is drawn, a comparison is done with the depth value already stored at the pixel. If the new pixel is closer than what's there, the new pixel's color and depth values replace those that are currently written into the pixel. If the new pixel's depth is greater than what's currently there, the new pixel is obscured, and the color and depth information for the incoming pixel is discarded. In an alternative embodiment, the depth buffering could occur via hardware instead of the CAD software as disclosed. It is understood that any comparable graphics library may be used, provided a feature similar to depth buffering is available. Likewise, a separate graphics library does not have to be used, but instead can be integral into the CAD software. Following the depth buffering, the final rendered image contains colored pixels that can be decoded and mapped back from the surface rendered to that location in the 3D assembly model, as orientated, with color values encoded with each surface as identified. This results in the software application providing graphical feedback to the designer by changing all processed faces identified as exterior of the various components to a solid color.

The quality of the rendering thus far can be further scrutinized and controlled by applying a plurality of filtering algorithms to the resulting image that removes rendering artifacts common with various rendering techniques. One such rendering artifact is called a speckle. The visibility solution can ignore these speckle anomalies by applying a commonly used speckle removal tool (Step 325). The speckle removal filter prevents speckles from affecting surrounding areas in the rendered image, which decreases the number of surfaces that comprise the final rendered image.

Following the application of filters to remove the rendering artifacts, the visibility solution extracts the rasterized surfaces (Step 330) and merges the resulting surfaces (Step 335) with a first visibility solution (Step 340). If the designer requires multiple orientations, then the visibility solution is not complete (Step 345) and the visibility solution returns to selecting the next orientation (Step 305) The 3D assembly model rendered from multiple orientations and the results from each orientation are accumulated to represent a composite visibility solution (Step 350) and whose result is returned for further processing and/or integration (Step 215)

Following the return for further processing, the designer has the ability to identify insignificant components by rotating, zooming in/out, etc., to inspect what the visibility solution identified as interior/exterior and re-run the solution to select additional exterior faces from that specific orientation. One of the benefits of the presently preferred embodiment is the components chosen to be excluded, still participate in the visibility solution.

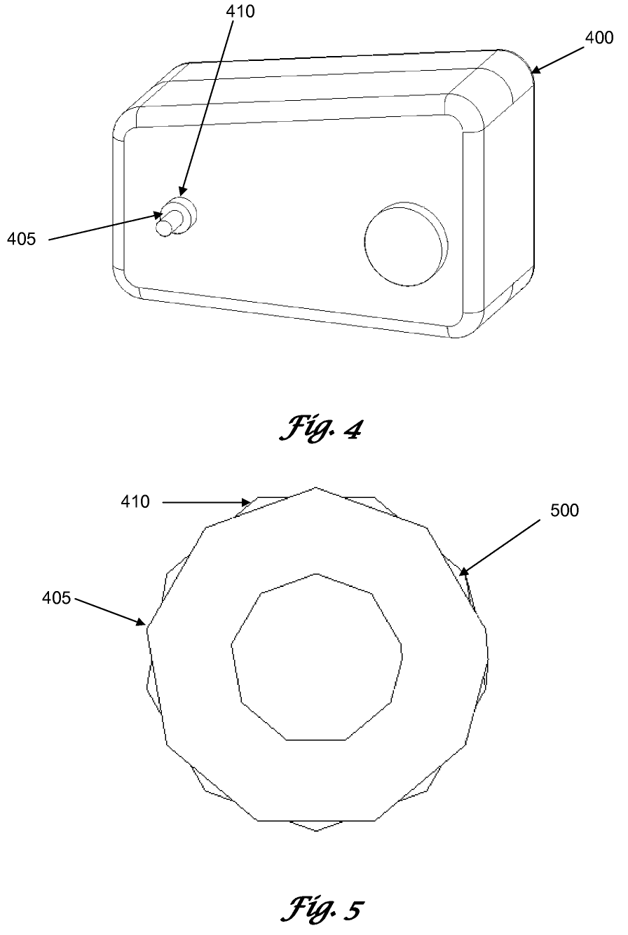

By way of example and not limitation, in FIG. 4, a 3D housing in axonometric orientation, the designer models a housing 400 having a shaft 405 extending outside the housing 400 through a hole 410 as further detailed in FIG. 5, an illustration of an orthogonal plane view of a shaft extended through a hole. During coarse granularity tessellation, a plurality of gaps can occur in the tessellated surfaces, e.g., the shaft 405 and the hole 410. The presently preferred embodiment calculates through the gaps to find at least one interior face 500 and identify the interior face 500 as exterior and/or visible. The designer then notes the interior face 500, and excludes it from the rendering.

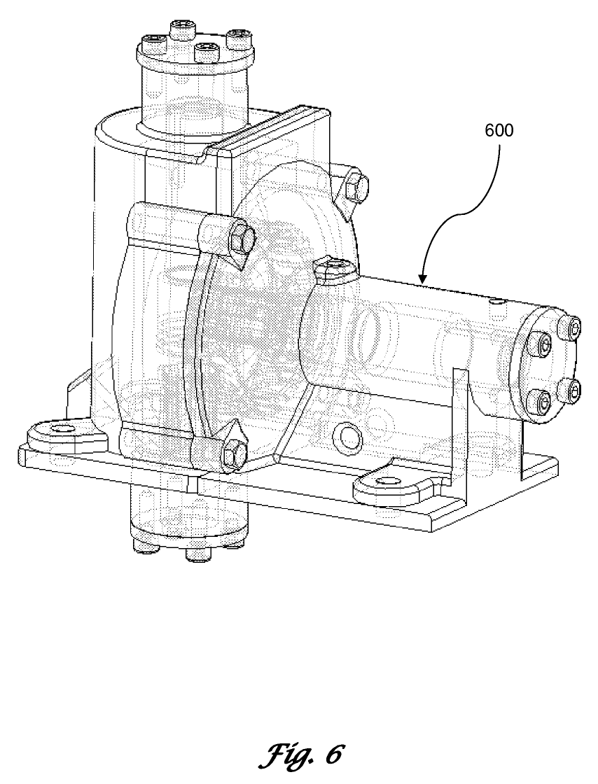

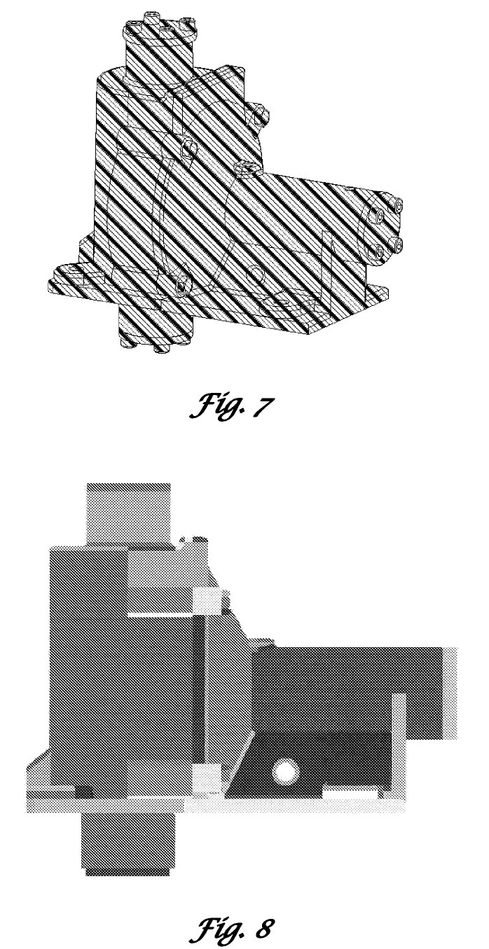

The presently preferred embodiment is illustrated, by way of example and not limitation, when the designer starts with FIG. 6, an axonometric orientation of a gear reducer assembly in design representation, and determines to create a simplified representation of a gear reducer assembly 600 by initiating the presently preferred embodiment which causes the gear reducer assembly to become one solid color with each part initially identified as interior as illustrated in FIG. 7, a 3D assembly model in axonometric orientation in one uniform color with each part initially identified as interior. In an alternative embodiment, FIG. 8 illustrates an orthogonal orientation of the gear reducer assembly with unique colors assigned to the various visible surfaces for each component.

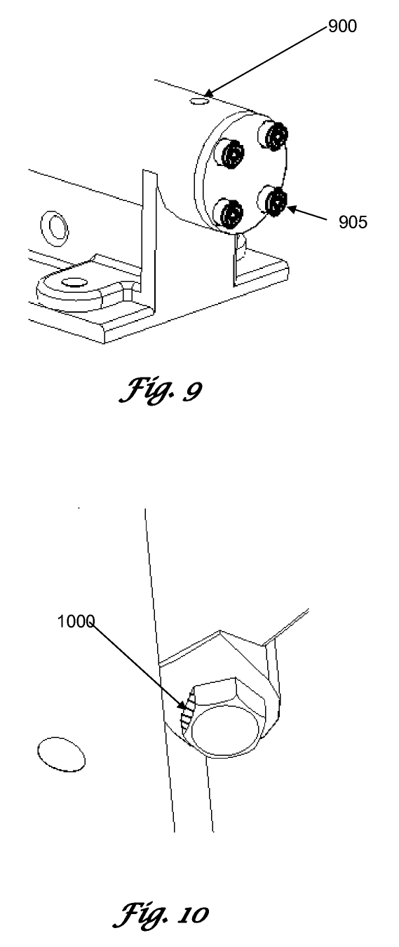

Prior to initiating the visibility solution, the user determines to ignore a small hole 900 and a plurality of small bolts 905 as illustrated in FIG. 9, a partial view of the gear reducer assembly, that will not be included in the complete simplified representation. The presently preferred embodiment allows the designer the ability to determine when to begin the visibility solution by displaying a process button. While processing, the presently preferred embodiment also provides the user the ability to cancel and review or modify the visibility solution when appropriate.

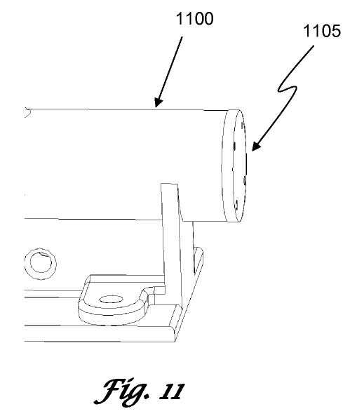

Following the rendering (Step 320) the designer views a gear reducer assembly, where FIG. 10 is a close-up view of a bolt and shows the exterior faces as white, and the interior faces as magenta, but illustrated in with a diagonal-line. While the visibility solution resolved the exterior faces, it calculates a bolt face 1000 as being interior, when in fact the bolt face 1000 is exterior to the gear reducer assembly 600. Utilizing the 3D software application, the designer then selects the bolt face 1000 as a member of the exterior faces that comprise the gear reducer assembly 600 by use of a mouse click or other known selection ability. FIG. 11 illustrates an axonometric orientation of the gear reducer assembly in simplified representation, the designer excluded the small hole 900 and the small bolts 905 that are not present as seen at 1100 and 1105, respectively.

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments have been described. It will be understood that various modifications may be made without departing from the spirit and scope of the presently preferred embodiment, for example the Direct3D library by Microsoft® could be used instead of the OpenGL library. Likewise, following rendering, should poor silhouette edges occur, then those edges can be further refined using various filtering schemes known in the art. Therefore, other implementations are within the scope of the following claims.

We claim:

1. A method to determine a visibility solution of a model comprising the steps of:
rendering a model having a plurality of parts with at least one color value encoded for an at least one corresponding surface identity;
distinguishing a plurality of exterior parts from a plurality of interior parts based on said at least one corresponding surface identity; and
identifying a plurality of features in said model not copied into a composite image.

2. The method of claim 1, further comprising the step of displaying said plurality of parts from at least one orientation.

3. The method of claim 1, further comprising the step of displaying said composite image comprised of said exterior parts and lacking said plurality of features.

4. The method of claim 1, further comprising the step of preparing said model to improve accuracy of a rendering operation.

5. The method of claim 1, further comprising the step of implementing at least one filtering algorithm to adjust a quality of analysis of said rendering.

6. The method of claim 1, further comprising the step of preparing said model to adjust accuracy of a rendering operation wherein said accuracy is adjusted by tessellating said model.

7. The method of claim 1, wherein said step of rendering operates to depict said model as a tessellated version of a geometrical representation of a plurality of surfaces.

8. A computer-program product tangibly embodied in a machine readable medium to perform a method to determine a visibility solution of a model, comprising:
instructions for rendering a model having a plurality of parts with at least one color value encoded for an at least one corresponding surface identity;
instructions for distinguishing a plurality of exterior parts from a plurality of interior parts based on said at least one corresponding surface identity; and
instructions for identifying a plurality of features in said model not copied into a composite image.

9. The computer-program product of claim 8, further comprising the instructions for displaying said plurality of parts from at least one orientation.

10. The computer-program product of claim 8, further comprising the instructions for displaying said composite image comprised of said exterior parts and lacking said plurality of features.

11. The computer-program product of claim 8, further comprising the instructions for preparing said model to improve accuracy of a rendering operation.

12. The computer-program product of claim 8, further comprising the instructions for implementing at least one filtering algorithm to adjust a quality of analysis of said rendering.

13. The computer-program product of claim 8, further comprising the instructions for preparing said model to adjust accuracy of a rendering operation wherein said accuracy is adjusted by tessellating said model.

14. The computer-program product of claim 8, wherein said instructions for rendering operates to depict said model as a tessellated version of a geometrical representation of a plurality of surfaces.

15. A data processing system having at least a processor and accessible memory to implement a method to determine a visibility solution of a model, comprising:
means for rendering a model having a plurality of parts with at least one color value encoded for an at least one corresponding surface identity;
means for distinguishing a plurality of exterior parts from a plurality of interior parts based on said at least one corresponding surface identity; and
means for identifying a plurality of features in said model not copied into a composite image.

16. A computer-program product for determining a visibility solution of a model, the solution comprising:
a rendering operation on a model, wherein said rendering operation encodes a plurality of parts with at least one color value to at least one corresponding surface identity;
a plurality of exterior parts distinguished from a plurality of interior parts based on said at least one corresponding surface identity;
whereby said model displays a composite image of said exterior parts.

17. A computer-program product for determining a visibility solution of a model, the product comprising:
a rendering operation that receives a prepared model, wherein said preparation adjusts accuracy of said rendering operation;
at least one filtering algorithm to adjust a quality of analysis following said rendering operation;
whereby said model is a tessellated version of a geometric representation of a plurality of surfaces.

18. A visibility solution of a model embodied on a computer-readable medium on a computer in conjunction with a application, the visibility solution comprising:
a reduced form of said model derived from a designed form of said model, having a plurality of exterior faces, wherein said exterior faces consist of a plurality of components from said design form.

19. A method to determine a visibility solution of a model comprising the steps of:
implementing at least one filtering algorithm to adjust a quality of analysis of said rendering;
preparing said model to adjust accuracy of a rendering operation wherein said accuracy is adjusted by tessellating said model;
rendering a model having a plurality of parts with at least one color value encoded for an at least one corresponding surface identity, operating to depict said model as a tessellated version of a geometrical representation of a plurality of surfaces;
distinguishing a plurality of exterior parts from a plurality of interior parts based on said at least one corresponding surface identity;
identifying a plurality of features in said model not copied into a composite image; and
displaying said composite image comprised of said exterior parts and lacking said plurality of features.
